(19) United States
(12) Patent Application Publication
(10) Pub. No.: US 2024/0183211 A1
(43) Pub. Date: Jun. 6, 2024

(54) METHOD FOR AUTOMATICALLY CONTROLLING AND CONTROLLER OF HOUSEHOLD-APPARATUS POSITION

(71) Applicant: ORANGE, Issy-les-Moulineaux (FR)

(72) Inventors: Christian Gregoire, CHATILLON CEDEX (FR); Rozenn Nicol, CHATILLON CEDEX (FR); Gildas Le Pennec, CHATILLON CEDEX (FR)

(21) Appl. No.: 18/526,467

(22) Filed: Dec. 1, 2023

(30) Foreign Application Priority Data
Dec. 5, 2022 (FR) 2212770

(51) Int. Cl. E05F 15/70

(52) U.S. Cl. CPC E05F 15/70; E05F 2015/763

(57) ABSTRACT

A method for automatic control of household-apparatus position, and in particular to fully opening, fully closing and partially opening, etc. French doors, roof windows (also called slanting skylights), French windows, doors, etc. the control method includes generating a command depending on an acquired audio signal, the generated command being able to trigger control by an actuator of a household apparatus, the actuator moving the household apparatus into a position that is dependent on the command. Thus, a number of automation contexts is increased and includes weather-unrelated contexts, for example nuisance-noise-related contexts, and, potentially, also weather-related contexts.

### CROSS-REFERENCE TO RELATED APPLICATIONS

This application claims priority to and the benefit of French Patent Application FR2212770, filed Dec. 5, 2022, the content of which is incorporated herein by reference in its entirety.

### TECHNICAL FIELD

The present disclosure relates to automatic control of household-apparatus position, and in particular to fully opening, fully closing and partially opening, etc. openable devices such as French doors, roof windows (also called slanting skylights), French windows, doors, etc.

### PRIOR ART

Control systems for automatically opening and closing household apparatuses such as windows already exist. Existing systems offer automation based on meteorological information: particularly whether it is rainy and/or windy. Thus, when the system for automatically controlling a window to open position is informed that it is windy or rainy in the place where the window is located, particularly by means of a wind or rain detector installed on or in the structure of the window, then the control system closes the window.

The rain sensors currently used by these window control systems are electromagnetic, hygroscopic or, more generally, optical. The wind sensor is particularly a vibration sensor (as in the case of awnings) or an anemometer.

Some automated windows, in the present case motorized windows, have a “night cooling” ventilation function that allows natural air-conditioning without additional energy costs. To optimize the use of night cooling, the sensors integrated into the windows are coupled to internal and external temperature sensors. Thus, when the sensed internal temperature is higher than a programmed internal temperature and the external temperature, this automation opens the windows.

Therefore, the opening/closing window automation is limited to a restricted number of automation contexts that depend on the sensors with which the window is equipped. The higher the number of automation contexts desired by the user, the more complex the window will be because the higher the number of sensors with which it will need to be fitted.

Optionally, to avoid over-equipping such windows, either the signal sensors are pooled, or a home-automation assistant automates window opening based on meteorological information provided by weather-forecasting websites. The risk then is related to inaccuracies in the weather forecast, and to the fact that data specific to the home (for example, indoor temperature, type of window: sliding window, French window, roof window such as a Velux™ window, etc.) are not taken into account.

Furthermore, regardless of the source of the information on which automation of window opening/closing is based, it is merely a question of meteorological information, this limiting the number of automation contexts.

### SUMMARY

One or more aspects of the present disclosure rectify some drawbacks/deficiencies of the prior art and/or make improvements to the prior art.

One aspect of the present disclosure is a method for automatically controlling household-apparatus position, this control method comprising generating a command depending on an acquired audio signal, generation of the command being triggered depending on the type of audio signal acquired, the generated command being able to trigger control by an actuator of a household apparatus, the actuator moving the household apparatus into a position that is dependent on the command.

Thus, the number of automation contexts is increased and includes weather-unrelated contexts, for example nuisance-noise-related contexts, and, potentially, also weather-related contexts.

Advantageously, the control method comprises audio-signal analysis of the acquired audio signal, the generated command being dependent on the result of analysis of the acquired audio signal.

Advantageously, the control method comprises audio-signal recognition of the acquired audio signal, the generated command being dependent on the recognized audio signal.

Advantageously, the control method comprises location of audio sources of the acquired audio signal, the generated command being dependent on the location of the audio sources of the acquired audio signal with respect to the position of a household apparatus.

Advantageously, the control method comprises prediction of how the acquired audio signal will vary after the time at which the audio is acquired.

Thus, when the position modification context is intermittent, for example an intermittent noise, the automation will avoid successively opening and closing the openable device, also called flip-flopping of the state of the window, in a way that might be annoying to a person present near the window or in the room in which the window is located. Furthermore, successively opening and closing the apparatus could lead to early wear of the parts (hinge, roller, etc.) solicited when the window changes position, this thus being less likely to occur.

Advantageously, the generated command is a command set depending on at least one predicted parameter of the acquired audio signal.

Thus, automation is implemented for example in set time slots, or for example depending on set values of acquired data, on detection of presence and/or absence, the window being closed automatically in case of a nuisance audio signal only if inside temperature is within a set temperature range, the window being opened automatically at the end of the nuisance audio signal only if no rain is detected, etc.

Advantageously, the control method comprises detection of a context of household-apparatus position modification depending on an acquired audio signal, detection of a context of household-apparatus position modification triggering command generation.

Advantageously, detection of a context of household-apparatus position modification is dependent on a criterion relating to the acquired audio signal from among the following criteria:
audio signal level of the acquired audio signal,
type of audio signal acquired,
predicted duration of the acquired audio signal,
predicted frequency of appearance of the acquired audio signal.

Advantageously, detection of a position modification context is dependent on at least one preconfigured control parameter.

Advantageously, according to one aspect of the disclosure, the various steps of the method of the disclosure are implemented by a software package or computer program, this software package comprising software instructions intended to be executed by a data processor of a controller and/or control system, particularly a home-automation assistant, and being designed to command execution of the various steps of this method.

An aspect of the disclosure therefore also relates to a program comprising program code instructions for executing the steps of the control method when said program is executed by a processor.

This program may use any programming language, and take the form of source code, of object code, or of code intermediate between source code and object code, such as code in partially compiled form or in any other desirable form.

Another aspect of the disclosure is an automatic controller of household-apparatus position, comprising a generator for generating a command depending on an acquired audio signal, the command generator being triggered depending on the type of audio signal acquired, the generated command being able to trigger control by an actuator of a household apparatus, the actuator moving the household apparatus into a position that is dependent on the command.

Advantageously, the command generator is able to generate a plurality of commands depending on an acquired audio signal, each generated command being able to trigger control by a separate actuator of a separate household apparatus.

Advantageously, a household apparatus is an apparatus from among the following:
an openable device such as a door or window;
a noise reducer;
an echo-cancelling device.

Furthermore, another aspect of the disclosure is a control system comprising:
an audio sensor co-located with a household apparatus;
an actuator of the household apparatus able to modify the position of the household apparatus;
an automatic controller of household-apparatus position, able to generate a command depending on an audio signal acquired by the sensor and triggered depending on the type of audio signal acquired, the generated command being able to trigger control by the actuator of the household apparatus, the actuator moving the household apparatus into a position that is dependent on the command.

Advantageously, the control system comprises a plurality of audio sensors co-located with separate household apparatuses, the position controller being able to generate a command for controlling the household apparatus co-located with the audio sensor that acquired the acquired audio signal depending on which the command was generated.

### BRIEF DESCRIPTION OF THE DRAWINGS

Features and advantages of the disclosure will become more clearly apparent on reading the description, which is given by way of example, and the related figures, in which:

FIG. 1 shows a simplified schematic of a method for automatically controlling household-apparatus position according to an aspect of the disclosure,

FIG. 2 shows a simplified schematic of a controller of household-apparatus position according to an aspect of the disclosure,

FIG. 3a shows a simplified schematic of one example of a situation of use of the controller of household-apparatus position according to an aspect of the disclosure,

FIG. 3b shows a simplified schematic of various positions of a sliding household apparatus automatically controlled by the controller according to an aspect of the disclosure, and

FIG. 3c shows a simplified schematic of various positions of a roof-mounted household apparatus automatically controlled by the controller according to an aspect of the disclosure.

### DESCRIPTION OF THE EMBODIMENTS

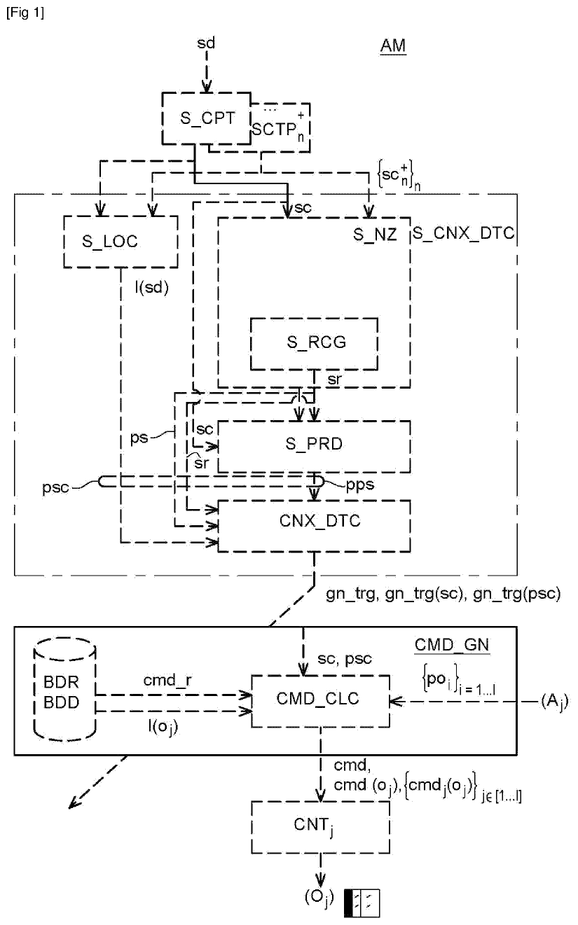

FIG. 1 illustrates a simplified schematic of a method for controlling household-apparatus position according to an aspect of the disclosure.

The method AM for controlling household-apparatus position comprises generating CMD_GN a command cmd, cmd(oⱼ) depending on an acquired audio signal sc, the generated command cmd, cmd(oⱼ) being able to trigger control CNTj by an actuator Aⱼ of a household apparatus Oⱼ, the actuator Aⱼ moving the household apparatus to a position posj depending on the command cmd, cmd(oⱼ). In particular, command generation is triggered depending on the type of audio signal acquired.

The expression “position of a household apparatus” is understood to mean the fully open and closed positions or one or more partially open positions of the openable device; one or more positions in which reverberation in a room is decreased by an echo-cancelling device; one or more noise-reducer positions, such as activation of a sound bubble; generally, one or more positions of a device for modifying acoustic characteristics of a building, or even of a room of a building or of a region of a building.

In particular, the control method AM comprises audio-signal analysis S_NZ of the acquired audio signal sc, the generated command cmd, cmd(oⱼ) being dependent on the result ps of analysis of the acquired audio signal.

In particular, the control method AM comprises audio-signal recognition S_RCG of the acquired audio signal sc, the generated command cmd, cmd(oⱼ) being dependent on the recognized audio signal sr.

In particular, the control method AM comprises location S_LOC of audio sources of the acquired audio signal sc, the generated command cmd, cmd(oⱼ) being dependent on the location I(sd) of the acquired audio signal sc with respect to the position of a household apparatus I(oⱼ).

In particular, the control method AM comprises prediction S_PRD of how the acquired audio signal will vary after the time at which the audio is acquired.

In particular, the generated command cmd, cmd(oⱼ) is a command cmd_r set depending on at least one predicted parameter pps of the acquired audio signal.

In particular, the control method AM comprises detection CNX_DTC of a context of household-apparatus position modification depending on an acquired audio signal sc, detection CNX_DTC of a context of household-apparatus position modification triggering gn_trg, gn_trg(sc), gn_trg(psc) command generation CMD_GN.

In particular, detection CNX_DTC of a context of household-apparatus position modification is dependent on a criterion relating to the acquired audio signal sc from among the following criteria:
audio signal level nv(sc) of the acquired audio signal,
type ty(sc) of audio signal acquired,
predicted duration T(sc) of the acquired audio signal,
predicted frequency of appearance fa(sc) of the acquired audio signal.

In particular, detection CNX_DTC of a position modification context is dependent on at least one preconfigured control parameter app.

In particular, the control method AM comprises audio acquisition S_CPT.

Optionally, the control method AM comprises one or more complementary audio acquisitions S_CPT⁺, {S_CPT⁺ₙ}ₙ, n=1 . . . N. The complementary audio acquisition S_CPT⁺ (case n=1) delivers a complementary acquired audio signal sc+, {sc⁺ₙ}ₙ and particularly allows location S_LOC of the source of the audio signal.

Optionally, the complementary acquired audio signal sc+, {sc⁺ₙ}ₙ comprises an additional audio signal sd⁺ transmitted by an additional source not acquired via the audio acquisition S_CPT or the transmitted additional audio signal of which is embedded in the audio signal acquired via the audio acquisition S_CPT, i.e. the audio level of the transmitted additional audio signal is low relative to the audio level of the acquired audio signal, or indeed the acquired audio signal does not allow the transmitted additional audio signal to be identified (for example it to be recognized, the type of sound to be identified, etc.).

In particular, the audio analysis S_NZ is performed on the acquired audio signal sc, and optionally on the complementary acquired audio signal sc+. In particular, the audio analysis S_NZ analyzes separately each of the acquired audio signals among the acquired audio signal sc and one or more complementary acquired audio signals {sc⁺ₙ}ₙ, or the acquired audio signals jointly. The expression “joint audio analysis” is particularly understood to mean that the audio analysis uses (intermediate or final) results of the analysis of one or more first acquired signals, for example the complementary acquired audio signals {sc⁺ₙ}ₙ, in the analysis of a second of the acquired signals, for example the acquired audio signal sc.

In particular, the audio analysis S_NZ determines one or more parameters ps of the acquired audio signal, particularly the audio level of the acquired signal, the audio frequency of the acquired signal, the type of signal acquired: noise, melody, natural sound (bird song, wind, etc.), mechanical sound, etc.

In particular, the audio recognition S_RCG is performed on the acquired audio signal sc, and optionally on the complementary acquired audio signal sc+. In particular, the audio recognition S_RCG recognizes one or more audio sources from which one or more transmitted audio signals sd contained in an acquired audio signal sc, or even in a complementary acquired audio signal sc+, respectively originate. The recognized audio signal sr delivered by the audio recognition S_RCG particularly comprises one or more data regarding the one or more audio sources recognized in the acquired audio signal sc, for example the type of audio source, an audio-source identifier, etc.

The audio recognition S_RCG recognizes these audio sources by processing each of the acquired audio signals among the acquired audio signal sc and one or more complementary acquired audio signals {sc⁺ₙ}ₙ separately, or the acquired audio signals jointly. The expression “joint audio recognition” is particularly understood to mean that the audio recognition uses (intermediate or final) results of processing of one or more first signals acquired by the audio recognition, for example the complementary acquired audio signals {sc⁺ₙ}ₙ, in the audio recognition of a second of the acquired signals, for example the acquired audio signal sc.

In particular, the audio analysis S_NZ includes the audio recognition S_RCG. The audio analysis S_NZ then delivers not only audio-analysis results, such as one or more parameters ps of the acquired audio signal, but also a recognized audio signal sr.

In particular, the location S_LOC of audio sources of the acquired audio signal sc allows the location of one or more audio sources, from the one or more transmitted audio signals sd of which the acquired audio signal sc is composed, to be determined. In particular, the location S_LOC uses the one or more complementary acquired audio signals {sc⁺ₙ}ₙ, thus allowing the accuracy of the location I(sd) thus determined to be improved. In particular, the determined location I(sd) is the distance between the audio source and an audio sensor performing the audio acquisition S_CPT, or even the relative position of the audio source with respect to the audio sensor (particularly taking the form of coordinates centered on the audio sensor, such as polar coordinates: distance, azimuth angle, and possibly polar angle, or Cartesian coordinates: abscissa, ordinate, and possibly level or height), or even the position of the audio source in a generic system: for example GPS coordinates.

In particular, the prediction S_PRD of the acquired audio signal sc estimates how the acquired audio signal sc will vary after the time at which the audio is acquired. The prediction S_PRD delivers predicted data pps such as: either a predicted audio signal based on which one or more predicted parameters of the acquired audio signal are determined, or directly one or more predicted parameters of the acquired audio signal sc. In particular, the prediction S_PRD makes it possible to estimate one or more of the following predicted parameters pps: if it is a question of a continuous or repetitive audio signal ca(sc)∈{cnt, rec}, the frequency of appearance of the acquired audio signal fap(sc), the predicted duration of the audio signal TP(sc), etc. Optionally, to make a prediction regarding the acquired audio signal sc, the prediction S_PRD uses at least one of the following data:
the result ps of the audio analysis S_NZ,
the recognized audio signal sr delivered by the audio recognition S_RCG.

In particular, the detection CNX_DTC of a context of household-apparatus position modification analyzes context depending on the acquired audio signal sc, and in particular depending on at least one datum from among the following:
the acquired audio signal sc delivered by the audio acquisition S_CPT;
the one or more complementary acquired audio signals {sc⁺ₙ}ₙ delivered by the one or more complementary audio acquisitions S_CPT⁺, {S_CPT⁺ₙ}ₙ;
the result ps of the audio analysis S_NZ;
the recognized audio signal sr delivered by the audio recognition S_RCG;
at least one location I(sd) determined by the audio-source location S_LOC;
predicted data pps relating to the acquired audio signal sc and delivered by the prediction S_PRD.

The context analysis carried out by the detection CNX_DTC of a context of household-apparatus position modification particularly makes it possible to estimate ES_EST the environmental situation (not illustrated): nuisance noise, weather, etc. Thus, the context detection CNX_DTC allows household-apparatus position modification to be triggered if the estimated environmental situation meets (CND_VRF) certain conditions of household-apparatus position modification.

These conditions of household-apparatus position modification are optionally predefined conditions, for example conditions cnx_cnd stored CND_W prior to use of the control method AM, particularly during prior configuration AM_CNF (not illustrated) of the control method. For example, a user of the control method enters CND_NTR (not illustrated) conditions cnx_cnd of household-apparatus position modification during this prior configuration AM_CNF. Alternatively or additionally, the conditions cnx_cnd of household-apparatus position modification are enriched based on habits of the user, particularly during a learning process, possibly one employing AI, implemented during this prior configuration AM_CNF.

Alternatively or additionally, at least some of the conditions of household-apparatus position modification are obtained CND_DT (not illustrated) through a learning process dependent on at least one instantaneous command of at least one actuator of a household apparatus originating from a user interface or a user terminal, or from a device such as a controller or home-automation assistant implementing the control method.

In particular, the context detection CNX_DTC is implemented by an artificial-intelligence device able to analyze the environmental situation, to determine CND_DT one or more contexts of household-apparatus position modification and to verify (CND_VRF) whether the analyzed environmental situation corresponds to at least one of these determined contexts.

When the context detection CNX_DTC determines that the context corresponds to a context of household-apparatus position modification, then the context detection triggers gn_trg generation CMD_GN of a command for an actuator of a household apparatus.

Optionally, the control method AM comprises audio-context detection S_CNX_DTC. The audio-context detection S_CNX_DTC comprises, in addition to the context detection CNX_DTC, one or more of the following steps:
the audio analysis S_NZ,
the audio recognition S_RCG,
the location S_LOC,
the prediction S_PRD.

The generation CMD_GN of a command for an actuator of a household apparatus uses data from among the following: acquired signal sc, and parameters psc relating to the acquired signal (particularly the result ps of the audio analysis S_NZ, the recognized data sr delivered by the audio recognition S_RCG, the predicted data pps delivered by the prediction S_PRD, the location I(sd) determined by the audio-source location S_LOC, etc.). These data sc, psc are delivered by the context detection CNX_DTC and/or the audio-context detection S_CNX_DTC either directly or in a trigger gn_trg used by the context detection CNX_DTC and/or the audio-context detection S_CNX_DTC to trigger the command generation CMD_GN.

In particular, the generation CMD_GN of a command for an actuator of a household apparatus further uses data relating to one or more household apparatuses {poᵢ}_{i, i=1 . . . I}, which data are particularly delivered by an actuator Aⱼ of the household apparatus Oi or I(oj) or by a database BDD.

In particular, the generation CMD_GN of a command for an actuator of a household apparatus further uses commands cmd_r preprogrammed depending on certain rules relating particularly to the acquired signal and/or to the household apparatuses Oi, which are particularly delivered by a rule database BDR.

In particular, the command generation CMD_GN comprises determining a command CMD_CLC particularly through a learning process and/or by means of an artificial-intelligence device.

In certain contexts detected CNX_DTC, generation CMD_GN of a plurality of commands {cmdⱼ(oⱼ)}ⱼ intended for actuators of separate household apparatuses {Oⱼ}_{j,j∈[1 . . . I]} is triggered gn_trg.

In particular, a household-apparatus control CNTj receives one of the one or more generated commands cmd, cmd(oⱼ). The control CNTj is implemented by an actuator Aj of the household apparatus Oj. The control CNTj causes the actuator Aj to modify the position posj of the household apparatus Oj.

Optionally, the generated command cmd, cmd(oⱼ), {cmdⱼ(oⱼ)}ⱼ comprises a commanded end position posj, or a position movement parameter (direction and/or value).

In particular, the control method AM comprises the household-apparatus control CNTj.

One particular embodiment of the method for automatically controlling household-apparatus position is a program comprising program code instructions for executing the steps of the control method when said program is executed by a processor.

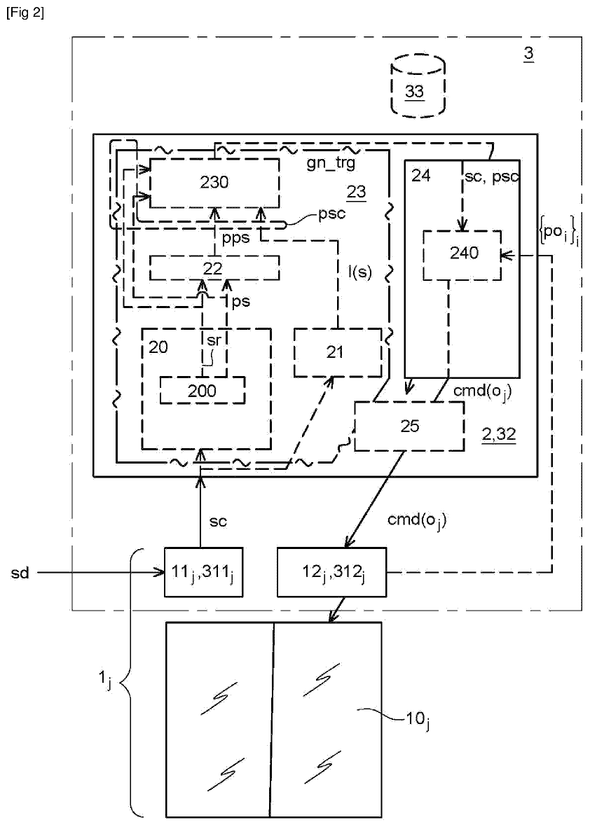

FIG. 2 illustrates a simplified schematic of a controller of household-apparatus position according to an aspect of the disclosure.

The controller 2,32 controls an actuator 12j, 312j able to modify the position of a household apparatus 10j. The controller 2,32 according to an aspect of the disclosure controls this actuator depending on an acquired sound sc delivered by at least one audio sensor 11j, 311j. In particular, it is triggered depending on the type of audio signal acquired.

In particular, a motorized household apparatus 1j comprises the actual household apparatus 10j and at least one actuator 12j, 312j. In the case of household apparatuses 10j equipped with a plurality of casements, such as French-style household apparatuses, sliding household apparatuses, etc., the motorized household apparatus 1j comprises one or more actuators, each actuator 12j, 312j being able to modify the position of one separate casement of the household apparatus 10j.

In particular, a household apparatus 1j able to be controlled by a controller 2,32 according to an aspect of the disclosure comprises an audio sensor 11j, 311j.

In a first embodiment, a controller 2, 32 of household-apparatus position comprises a command generator 24 for generating a command cmd depending on an acquired audio signal sc. The generated command cmd is able to trigger control cntⱼ by an actuator 12j, 312j of a household apparatus 10j, the actuator moving the household apparatus into a position dependent on the command. In particular, the command generator is triggered depending on the type of audio signal acquired.

In particular, the command generator 24 is able to generate a plurality of commands {cmdⱼ(oⱼ)}ⱼ depending on an acquired audio signal sc, each generated command cmdⱼ(oⱼ) being able to trigger control cntj by a separate actuator 12j of a separate household apparatus 10j.

In a second particular embodiment, a control system 3 comprises:
an audio sensor 311j co-located with a household apparatus 10j;
an actuator 312j of the household apparatus 10j able to modify the position posj of the household apparatus;
a controller 32 of household-apparatus position, able to generate a command cmdⱼ(oⱼ) depending on an audio signal sc acquired by the audio sensor 311j, the generated command cmdⱼ(oⱼ) being able to trigger control cntj by the actuator 312j of the household apparatus 10j, the actuator 312j moving the household apparatus into a position that is dependent on the command. In particular, the position controller is able to generate a command triggered depending on the type of audio signal acquired.

Optionally, the control system 3 comprises one or more complementary audio sensors (not illustrated). The complementary audio sensor delivers a complementary acquired audio signal sc+, {sc⁺ₙ}ₙ and particularly allows location of the source of the audio signal.

In particular, the control system 3 comprises a plurality of audio sensors (not illustrated) co-located with separate household apparatuses {10j}ⱼ, the position controller 32 being able to generate a command cmd(oⱼ) for controlling the household apparatus 10j co-located with the audio sensor 311j that acquired the acquired audio signal depending on which the command was generated.

In particular, the controller 2,32 comprises an audio analyzer 20 able to analyze an acquired audio signal sc. The generated command cmd, cmd(oⱼ) is dependent on the result ps of analysis of the acquired audio signal.

In particular, the audio analyzer 20 is able to process the acquired audio signal sc, and optionally a complementary acquired audio signal sc+. In particular, the audio analyzer 20 analyzes separately each of the acquired audio signals among the acquired audio signal sc and one or more complementary acquired audio signals {sc⁺ₙ}ₙ, or the acquired audio signals jointly. The expression “joint audio analysis” is particularly understood to mean that the audio analysis uses (intermediate or final) results of the analysis of one or more first acquired signals, for example the complementary acquired audio signals {sc⁺ₙ}ₙ, in the analysis of a second of the acquired signals, for example the acquired audio signal sc.

In particular, the audio analyzer 20 is able to determine one or more parameters ps of the acquired audio signal, particularly the audio level of the acquired signal, the audio frequency of the acquired signal, the type of signal acquired: noise, melody, natural sound (bird song, wind, etc.), mechanical sound, etc.

In particular, the controller 2,32 comprises an audio recognition device 200 able to process the acquired audio signal sc. The generated command cmd, cmd(oⱼ) is dependent on the recognized audio signal sr.

In particular, the audio recognition device 200 is able to process the acquired audio signal sc, and optionally the complementary acquired audio signal sc+. In particular, the audio recognition device 200 is able to recognize one or more audio sources from which one or more transmitted audio signals sd contained in an acquired audio signal sc, or even in a complementary acquired audio signal sc+, respectively originate. The recognized audio signal sr delivered by the audio recognition S_RCG particularly comprises one or more data regarding the one or more audio sources recognized in the acquired audio signal sc, for example the type of audio source, an audio-source identifier, etc.

The audio recognition device 200 is able to recognize these audio sources by processing each of the acquired audio signals among the acquired audio signal sc and one or more complementary acquired audio signals {sc⁺ₙ}ₙ separately, or the acquired audio signals jointly. The expression “joint audio recognition” is particularly understood to mean that the audio recognition uses (intermediate or final) results of processing of one or more first signals acquired by the audio recognition, for example the complementary acquired audio signals {sc⁺ₙ}ₙ, in the audio recognition of a second of the acquired signals, for example the acquired audio signal sc.

In particular, the audio analyzer 20 comprises the audio recognition device 200. The audio analyzer 20 is then able to deliver not only audio-analysis results, such as one or more parameters ps of the acquired audio signal, but also a recognized audio signal sr.

In particular, the controller 2,32 comprises a locator 21 of audio sources of the acquired audio signal sc. The generated command cmd, cmd(oⱼ) is dependent on the location I(sd) of the acquired audio signal sc with respect to the position of a household apparatus I(oⱼ).

In particular, the locator 21 of audio sources of the acquired audio signal sc is able to determine the location of one or more audio sources, from the one or more transmitted audio signals sd of which the acquired audio signal sc is composed. In particular, the locator 21 uses the one or more complementary acquired audio signals {sc⁺ₙ}ₙ thus allowing the accuracy of the location I(sd) thus determined to be improved. In particular, the determined location I(sd) is the distance between the audio source and an audio sensor performing the audio acquisition S_CPT, or even the relative position of the audio source with respect to the audio sensor (particularly taking the form of coordinates centered on the audio sensor, such as polar coordinates: distance, azimuth angle, and possibly polar angle, or Cartesian coordinates: abscissa, ordinate, and possibly level or height), or even the position of the audio source in a generic system: for example GPS coordinates.

In particular, the controller 2,32 comprises a prediction device 22 for predicting how the acquired audio signal will vary after the time at which the audio is acquired.

In particular, the device 22 for predicting the acquired audio signal sc is able to estimate how the acquired audio signal sc will vary after the time at which the audio is acquired. The prediction device 22 is able to deliver predicted data pps such as: either a predicted audio signal based on which one or more predicted parameters of the acquired audio signal are determined, or directly one or more predicted parameters of the acquired audio signal sc. In particular, the prediction device 22 is able to estimate one or more of the following predicted parameters pps: if it is a question of a continuous or repetitive audio signal ca(sc)∈{cnt, rec}, the frequency of appearance of the acquired audio signal fap(sc), the predicted duration of the audio signal TP(sc), etc. Optionally, to make a prediction regarding the acquired audio signal sc, the prediction device 22 is able to use at least one of the following data:
the result ps of the audio analyzer 20,
the recognized audio signal sr delivered by the audio recognition device 200.

In particular, the controller 2,32 comprises a detector 230 of a context of household-apparatus position modification depending on an acquired audio signal sc. The detector 230 of a context of household-apparatus position modification triggers gn_trg, gn_trg(sc), gn_trg(psc) command generation, particularly by the command generator 24.

In particular, the detector 230 of a context of household-apparatus position modification verifies whether the current context corresponds to a context of household-apparatus position modification depending on a criterion relating to the acquired audio signal sc from among the following criteria:
audio signal level nv(sc) of the acquired audio signal,
type ty(sc) of audio signal acquired,
predicted duration T(sc) of the acquired audio signal,
predicted frequency of appearance fa(sc) of the acquired audio signal.

In particular, the detector 230 of a position modification context verifies whether the current context corresponds to a context of household-apparatus position modification depending on at least one preconfigured control parameter app.

In particular, the detector 230 of a context of household-apparatus position modification CNX_DTC comprises a context analyzer (not illustrated) that analyzes context depending on the acquired audio signal sc, and in particular depending on at least one datum from among the following:
the acquired audio signal sc delivered by the audio sensor 11, 311j;
the one or more complementary acquired audio signals {sc⁺ₙ}ₙ delivered by the one or more complementary audio sensors (not illustrated);
the result ps of the audio analyzer 20;
the recognized audio signal sr delivered by the audio recognition device 200;
at least one location I(sd) determined by the audio-source locator 21;
predicted data pps relating to the acquired audio signal sc and delivered by the prediction device 22.

The context analyzer of the detector 230 of a context of household-apparatus position modification is particularly able to estimate the environmental situation: nuisance noise, weather, etc. Thus, the context detector 230 is able to trigger household-apparatus position modification if the estimated environmental situation meets certain conditions of household-apparatus position modification.

These conditions of household-apparatus position modification are optionally predefined conditions, for example conditions cnx_cnd stored prior to use of the controller 2,32, particularly during prior configuration of the controller 2,32. For example, a user of the controller enters conditions cnx_cnd of household-apparatus position modification during this prior configuration, particularly by means of a user interface (not illustrated).

Alternatively or additionally, at least some of the conditions of household-apparatus position modification are obtained CND_DT (not illustrated) through a learning process dependent on at least one instantaneous command of at least one actuator of a household apparatus originating from a user interface or a user terminal, or from a device such as a controller or home-automation assistant implementing the control method.

In particular, the context detector 230 comprises an artificial-intelligence device able to analyze the environmental situation and/or to determine one or more contexts of household-apparatus position modification and to verify whether the analyzed environmental situation corresponds to at least one of these determined contexts.

When the context detector 230 determines that the context corresponds to a context of household-apparatus position modification, then the context detector 230 is able to trigger gn_trg generation, by a command generator 24, of a command for an actuator 12j,312j of a household apparatus 10j.

Optionally, the controller 2, 32 comprises an audio-context detector 23. The audio-context detector 23 comprises, in addition to the context detector 230, one or more of the following devices:
the audio analyzer 20,
the audio recognition device 200,
the locator 21,
the prediction device 22.

The generator 24 of a command for an actuator of a household apparatus is particularly able to use data from among the following: acquired signal sc, and parameters psc relating to the acquired signal (particularly the result ps delivered by the audio analyzer 20, the recognized data sr delivered by the audio recognition device 200, the predicted data pps delivered by the prediction device 22, the location I(sd) determined by the locator 21, etc.). These data sc, psc are delivered by the context detector 230 and/or the audio-context detector 23 either directly or in a trigger gn_trg used by the context detector 230 and/or the audio-context detector 23 to trigger the command generator 24.

In particular, the generator 24 of a command for an actuator of a household apparatus further uses data relating to one or more household apparatuses {poᵢ}_{i, i=1 . . . I}, which data are particularly delivered by an actuator Aj of the household apparatus Oi or I(oj) or by a database BDD.

In particular, the generator 24 of a command for an actuator of a household apparatus is further able to use commands cmd_r preprogrammed depending on certain rules relating particularly to the acquired signal and/or to the household apparatuses Oi, which are particularly delivered by a rule database 33.

In particular, the command generator 24 comprises a device 240 for determining a command, particularly through a learning process and/or by means of an artificial-intelligence device.

In certain contexts detected, generation, by the command generator 24, of a plurality of commands {cmdⱼ(oⱼ)}ⱼ intended for actuators of separate household apparatuses {10ⱼ}_{j,j∈[1 . . . I] is triggered gn_trg.}

In particular, the controller 2, 32 comprises a transmitter 25 able to transmit the command cmd(oⱼ) generated by the command generator 24 to an actuator 12j, 312j, particularly when the command generator 24 and the actuator 12j, 312j are not co-located.

In particular, an actuator 12j,312j receives one of the one or more generated commands cmd, cmd(oⱼ). The actuator 12j, 312j is then able to control the household apparatus 10j depending on the command cmd, cmd(oⱼ), this control CNTj causing the actuator 12j, 312j to modify the position posj of the household apparatus 10j.

Optionally, the generated command cmd, cmd(oⱼ), {cmdⱼ(oⱼ)}ⱼ comprises a commanded end position posj, or a position movement parameter (direction and/or value).

Optionally, the generated command cmd, cmd(oⱼ), {cmdⱼ(oⱼ)}ⱼ comprises an identifier of the actuator 12j, 312j to which the command is addressed and/or of the household apparatus 10j the position of which is to be modified.

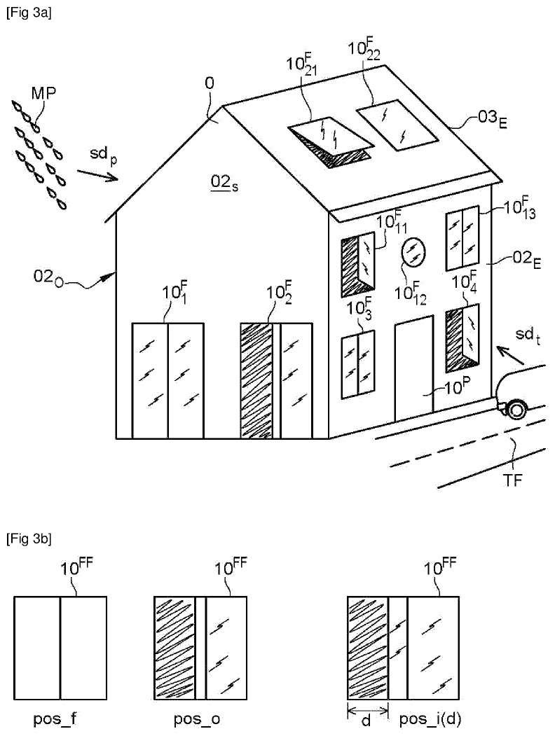

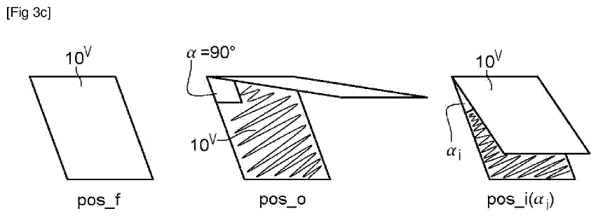

FIGS. 3a to 3b illustrate a use case with various positions of various types of household apparatus.

FIG. 3a illustrates a simplified schematic of one example of a situation of use of the controller of household-apparatus position according to an aspect of the disclosure.

The case considered is that of a dwelling 0 comprising a plurality of exterior household apparatuses: particularly an entrance door 10^{P}, sliding patio doors 10^{F}₁, 10^{F}₂ on the south facade 02_{S}, French windows 10^{F}₃, 10^{F}₄, 10^{F}₁₁, 10^{F}₁₂, 10^{F}₁₃ on the east facade 02_{E}, and roof windows 10^{F}₂₁, 10^{F}₂₂ on the east roof 03_{E}.

The dwelling 0 is equipped with one or more audio sensors 11j, 311j and with a controller 2, 32 according to an aspect of the disclosure (not shown).

The audio sensors acquire one or more audio signals from the outside environment: weather-related sounds such as the noise sdₚ of rain MP, mechanical sounds such as the noise sdₜ of traffic TF, etc.

The controller 2, 32 makes it possible to generate, depending on the acquired audio, a command for at least one of the household apparatuses 10^{P}, 10^{F}₁, 10^{F}₂, 10^{F}₃, 10^{F}₄, 10^{F}₁₁, 10^{F}₁₂, 10^{F}₁₃, 10^{F}₂₁, 10^{F}₂₂ of the dwelling 0.

Consider the example where the acquired audio signal sc contains the sound of rain sdₚ. In this context, the controller 2, 32 is able to generate:
commands to close:
either all the household apparatuses of the dwelling still open, in the present case patio door 10^{F}₂, French windows 10^{F}₄, 10^{F}₁₁, and roof window 10^{F}₂₁;
or household apparatuses of certain facades depending on the direction of the rain, in the present case the north, west and south facades 10^{F}₂, if the controller is able to determine the direction of the rain, which in the present case is from the west.
commands to decrease the openness of household apparatuses of certain facades depending on the direction of the rain, in the present case the east facade 10^{F}₄, 10^{F}₁₁, 10^{F}₂₁, if the controller is able to determine the direction of the rain, which in the present case is from the west.

Optionally, when the sound of rain ceases, the controller 2, 32 is able to generate a command to open the household apparatuses that were open prior to detection of this sound of rain sdₚ.

Consider the example where the acquired audio signal sc contains the sound sdₜ of constant or regular traffic at an audio level considered to be intrusive. In this context, the controller 2, 32 is able to generate:
commands to close:
either all the household apparatuses of the dwelling still open, in the present case patio door 10^{F}₂, French windows 10^{F}₄, 10^{F}₁₁, and roof window 10^{F}₂₁;
or household apparatuses of certain facades depending on the position of the traffic TF, in the present case the west and south facades 10^{F}₂, 10^{F}₄, 10^{F}₁₁, 10^{F}₂₁, if the controller is able to determine the location of the traffic TF with respect to dwelling 0, in the present case the road being to the south.

Optionally, when the sound of traffic ceases, the controller 2, 32 is able to generate a command to open the household apparatuses that were open prior to detection of this sound of traffic sdₜ.

Thus, when the environment is noisy and opening one or more household apparatuses will be bothersome to the occupants, the controller 2, 32 allows the position of one or more household apparatuses to be modified, and particularly one or more openable devices such as doors or windows to be completely closed in order to isolate the occupants from environmental noise, a sound bubble generated by a noise reducer to be activated, etc. It will be noted that, in the example, the environmental noise is exterior noise and the household apparatuses are household apparatuses on an exterior facade of a building, but one or more aspects of the disclosure may also be applied to interior household apparatuses, particularly between two rooms or between a room and conduit of traffic (a hallway particularly) of a building in the case of internal environmental noise, for example to automatically close the door of a meeting room or of an office when a number of people are chatting in the hallway or at a nearby beverage dispenser or when a tool, in particular a printer, is making a noise and has been doing so for an annoying amount of time.

One solution would be for the controller 2, 32, in particular the context detector 230, to be able to determine the audio level of the noise in the acquired audio signal sc and to trigger generation of a close command if the audio level of the noise is higher than a preconfigured threshold audio level (particularly one preconfigured by an occupant or administrator of the building).

Nevertheless, the source of the noise may therefore be continuous or temporary. When the noises are intermittent, it may be more disturbing to repetitively open and close the one or more openable devices, i.e. to generate an erratic oscillation in the position of the openable device, also called flip-flopping of the openable device. In this case, the rule applied by the controller 2, 32 may be to close, or even keep closed, the openable device, i.e. the household apparatus remains in the closed position throughout.

Another additional or alternative solution would be for the controller 2, 32, and in particular the context detector 230, to be able to determine one or more noise-related data particularly from among the following:
data relating to the type of noise, which type is determined by an audio analyzer 20 and/or an audio recognition device 200,
the frequency of appearance of the noise, which frequency is determined by the audio prediction device 22,
the predicted duration of the noise, which predicted duration is determined by the audio prediction device 22,
etc.;
   and to trigger generation of a close command depending on these noise-related data.

Thus, the controller 2,32 is able to determine, or even to recognize, the types of sounds acquired, particularly using artificial-intelligence or AI technologies. Depending on the type of sound, the controller 2, 32 is able to determine whether it is relevant to close/open the openable device. Specifically, for a brief noise (passage of a single aircraft for example), the time taken closing/opening makes the operation irrelevant. For a longer noise (for example, when a neighbor is mowing her or his lawn), the controller 2, 32 is able to determine that closing the household apparatus is more relevant.

Furthermore, the controller 2, 32 is able to adapt, by means of artificial-intelligence technologies, its response to an individual context, to the environment of a building, or even to a room of a building (house, office, etc.), and generally to the habits of the user and/or the way in which the building is normally used, particularly as determined by analysis, detection and/or recognition.

In particular, the audio analysis 20, or even the audio recognition 200, is particularly able to classify sounds, for example into two classes: pleasant sounds and unpleasant sounds. By unpleasant and pleasant sounds, what is meant are sounds that would lead an occupant to close or not close household apparatuses, respectively. It will be noted that a sound will potentially be classified pleasant or unpleasant depending on the occupant's activity context (napping, meditating, working, reading, gaming, chatting, making a phone call, etc.). Thus, the song of a bird or certain music may be considered to be pleasant and therefore not intrusive. This depends on the tastes of each individual, and on the time of day: the song of a bird in the early morning may shorten sleep, gentle music will not interfere with a conversation but symphonic music or a hard-rock song will, etc.

In particular, the controller 2,32 is able to take into account occupancy or inoccupancy of the building, or even of the room, in which a household apparatus is placed.

In order to respect the security of the property, the controller 2, 32 will only generate a command to open household apparatuses when certain security conditions are met and, optionally, will prefer a position modification command allowing the household apparatuses to be partially opened with an angle and/or width less than or equal to a security angle and/or a security width of the household apparatus, which is secure when it has this security angle and/or this security width, respectively. For example, in the case of tilt-and-turn household apparatus, the household apparatus being secure in tilt mode but not in turn mode, the controller 2, 32 is able to open this household apparatus only in tilt mode in the case where the security conditions are not met.

FIG. 3b illustrates a simplified schematic of various positions of a sliding household apparatus automatically controlled by the controller according to an aspect of the disclosure.

The sliding household apparatus 10_{FF} is able to adopt a plurality of positions:
a fully closed position pos_f;
a fully open position pos_o;
a partially open position pos_i(d) defined by the width d of the opening.

FIG. 3c illustrates a simplified schematic of various positions of a roof-mounted household apparatus automatically controlled by the controller according to an aspect of the disclosure.

The roof-mounted household apparatus 10v, which is particular a Velux™ window, is able to adopt a plurality of positions:
a fully closed position pos_f;
a fully open position pos_o in which the casement of the window particularly makes an angle α of 90° to the frame of the window;
a partially open position pos_i(αᵢ) defined by the angle αᵢ of the opening.

The various aspects of the disclosure are aspects that can be implemented alone or in combination with one or more others.

An aspect of the disclosure also relates to a data medium. The data medium may be any entity or device capable of storing the program. For example, the medium may include a storage means, such as a ROM, for example a CD-ROM or a microelectronic circuit ROM, or else a magnetic storage means, for example a floppy disk or a hard disk.

Moreover, the data medium may be a transmissible medium such as an electrical or optical signal, which may be routed via an electrical or optical cable, by radio or by other means. The program according to an aspect of the disclosure may in particular be downloaded from a network, and particularly from the Internet.

Alternatively, the data medium may be an integrated circuit into which the program is incorporated, the circuit being configured to execute or to be used in the execution of the method in question.

In another implementation, an aspect of the disclosure is implemented by way of software and/or hardware components. With this in mind, the term module may correspond equally to a software component or to a hardware component. A software component corresponds to one or more computer programs, one or more subroutines of a program or, more generally, to any element of a program or of software package that is able to implement a function or a set of functions in accordance with the above description. A hardware component corresponds to any element of a hardware assembly that is able to implement a function or a set of functions.

What is claimed is:

1. A control method for automatically controlling a household apparatus position, the control method being implemented by a control device and comprising:
generating a command depending on an acquired audio signal, the generating of the command being triggered depending on a type of audio signal acquired; and
transmitting the generated command to an actuator of the household apparatus, the generated command being able to trigger control by the actuator of the household apparatus, the actuator moving the household apparatus into a position that is dependent on the command.

2. The control method as claimed in the claim 1, the control method comprising audio-signal analysis of the acquired audio signal, the generated command being dependent on a result of the analysis of the acquired audio signal.

3. The control method as claimed in claim 1, the control method comprising audio-signal recognition of the acquired audio signal, the generated command being dependent on the recognized audio signal.

4. The control method as claimed in claim 1, the control method comprising a location of an audio source of the acquired audio signal, the generated command being dependent on the location of the audio source of the acquired audio signal with respect to the position of the household apparatus.

5. The control method as claimed in claim 1, the control method comprising prediction of how the acquired audio signal will vary after a time at which the audio signal is acquired.

6. The control method as claimed in claim 5, wherein the generated command is a command set depending on at least one predicted parameter of the acquired audio signal.

7. The control method as claimed in claim 1, the control method comprising detecting a context of a modification of the position of the household apparatus depending on the acquired audio signal, wherein the detecting of the context triggers the command generation.

8. The control method as claimed in claim 7, wherein detection of the context is dependent on a criterion relating to the acquired audio signal from among the following criteria:
audio signal level of the acquired audio signal,
the type of audio signal acquired,
predicted duration of the acquired audio signal,
predicted frequency of appearance of the acquired audio signal.

9. The control method as claimed in claim 7, wherein detection of the context is dependent on at least one preconfigured control parameter.

10. A non-transitory computer readable medium comprising a program stored thereon comprising program code instructions for executing the control method as claimed in claim 1 when said program is executed by a processor of the control device.

11. An automatic controller device of a position of at least one household apparatus, the automatic controller device comprising:
at least one processor; and
at least one non-transitory computer readable medium comprising instructions stored thereon which when executed by the at least one processor configure the automatic controller device to:
generate at least one command depending on at least one acquired audio signal, the generating of the at least one command being triggered depending on a type of the at least one audio signal acquired; and
transmit the at least one generated command to at least one actuator of the at least one household apparatus, the at least one generated command being able to trigger control by the at least one actuator of the at least one household apparatus, the at least one actuator moving the at least one household apparatus into a position that is dependent on the at least one command.

12. The automatic controller device as claimed in claim 11, wherein the instructions further configure the device to generate a plurality of commands depending on the at least one acquired audio signal, each generated command being able to trigger control by a separate actuator of a separate household apparatus.

13. The automatic controller as claimed in claim 12, wherein a household apparatus of the at least one household apparatus is an apparatus from among the following:
an openable device;
a noise reducer;
an echo-cancelling device.

14. A control system comprising:
an audio sensor co-located with a household apparatus;
an actuator of the household apparatus connected to modify a position of the household apparatus; and
an automatic controller device comprising at least one processor configured to:
generate a command depending on an audio signal acquired by the audio sensor, the generating of the command being triggered depending on a type of audio signal acquired; and
transmit the generated command to the actuator of the household apparatus, the generated command being able to trigger control by the actuator of the household apparatus, the actuator moving the household apparatus into a position that is dependent on the command.

15. The control system as claimed in claim 1, the control system comprising a plurality of audio sensors co-located with separate household apparatuses, the automatic controller being configured to generate a command for controlling the household apparatus co-located with the audio sensor that acquired the acquired audio signal.
